(19) United States
(12) Patent Application Publication
(10) Pub. No.: US 2022/0194817 A1
(43) Pub. Date: Jun. 23, 2022

(54) DEVICE AND METHOD FOR DEGRADING CHLORINATED HYDROCARBONS IN POLLUTED GROUNDWATER

(71) Applicants: Shanghai Environmental Engineering Design & Research Institute Co., Ltd., Shanghai (CN); Shanghai Environmental & Sanitary Engineering Design Institute Co., Ltd., Shanghai (CN); Shanghai Jiao Tong University, Shanghai (CN)

(72) Inventors: Lijie SONG, Shanghai (CN); Hui LIU, Shanghai (CN); Guobiao LI, Shanghai (CN); Shanping CHEN, Shanghai (CN); Miao AN, Shanghai (CN); Jun TAI, Shanghai (CN); Ruina ZHANG, Shanghai (CN)

(73) Assignees: Shanghai Environmental Engineering Design & Research Institute Co., Ltd., Shanghai (CN); Shanghai Environmental & Sanitary Engineering Design Institute Co., Ltd., Shanghai (CN); Shanghai Jiao Tong University, Shanghai (CN)

(21) Appl. No.: 17/536,020

(22) Filed: Nov. 27, 2021

(30) Foreign Application Priority Data
Dec. 18, 2020 (CN) 202011502376.4

(51) Int. Cl. C02F 1/32; C03B 25/00; C03C 3/12; C03C 3/14

(52) U.S. Cl. CPC C02F 1/325; C03B 25/00; C02F 2101/32; C03C 3/14; C03C 3/122

(57) ABSTRACT

The present disclosure relates to a device and method for degrading chlorinated hydrocarbon (CHC) in polluted groundwater. A preparation method for each of glass tubes and the method for degrading CHCs are as follows: uniformly mixing 55-85 wt % of Bi₂O₃, 5-15 wt % of B₂O₃, and 10-30 wt % of SrCO₃, putting into a corrosion resistant crucible, holding at 1,050-1,300° C. for 15-45 min, forming into a glass tube, and holding the glass tube at 200-400° C. for 1-3 h, followed by annealing; soaking the inner wall of the glass tube for 10-30 min with a HCl solution with a concentration of 0.02-0.2 mol/L, washing with water, and providing an ultraviolet lamp to obtain a self-cleaning glass tube; guiding CHC-containing groundwater to the self-cleaning glass tube, turning on the ultraviolet lamp, and carrying out ultraviolet irradiation for 1-8 h, thereby effectively removing the CHCs.

### CROSS REFERENCE TO RELATED APPLICATION

This patent application claims the benefit and priority of Chinese Patent Application No. 202011502376.4, filed on Dec. 18, 2020, the disclosure of which is incorporated by reference herein in its entirety as part of the present application.

### TECHNICAL FIELD

The present disclosure belongs to the technical field of chlorinated hydrocarbon (CHC) degradation, and in particular, to a device and method for degrading CHCs in polluted groundwater.

### BACKGROUND ART

CHCs are compounds derived by partially or wholly replacing hydrogen atoms in hydrocarbon molecules with chlorine atoms, and have been widely applied to fields like chemicals, medicines and pesticides as the important organic solvents and intermediate products. Due to improper use and storage, the CHCs are released to the natural environment by means of volatilization, leakage and wastewater discharge, thus posing a detrimental impact on the environment and human health. With a density greater than that of water, the CHCs are easily deposited in bottom water and diffused to groundwater to cause the extensive and persistent pollution to the groundwater for a long time. While increasingly higher domestic and international requirements are put forward to the ecological environment in sustainable development, the development of technologies for treating CHC polluted groundwater has become a focus of attention in the site remediation field at home and abroad.

To address the above technical problem, numerous useful attempts have been made in the prior art to form a series of pollution control technologies for CHCs, including adsorption, air stripping, biological treatment and chemical treatment, etc. However, these treatment technologies all have their defects: The adsorption is merely to transfer the pollutants rather than remove them in spite of effective adsorption for the CHCs. The air stripping is to move the CHCs in water to a gas phase to generate new pollutants for collection and further treatment. The biological treatment is only applied to controlling low concentrations of CHC pollutants, with a slow biodegradation rate and a long treatment period. The chemical treatment needs to additionally add chemical agents to cause secondary pollution.

In recent years, degradation of organic pollutants in water with semiconductor photocatalysts has received more attentions. It is revealed that the semiconductor photocatalysts such as BiOCl, TiO₂ and ZnO are environment-friendly, economical, practical and effective to degrade the CHCs (refer to Liu Wei. Degradation and Mechanism of Typical Chlorinated Hydrocarbons under Ultraviolet Irradiation [D]. China University of Geosciences, 2018.). However, the conventional photocatalysis involves the addition of catalytic nanoparticles. The nanomaterials are still likely to cause the secondary pollution, with the failure of the catalyst as well as the complicated recycling and separation.

### SUMMARY

In view of the above defects, the present disclosure provides a device and method for catalytically degrading CHCs in polluted groundwater without a catalyst.

The present disclosure is implemented upon a principle that a BiOCl semiconductor photocatalyst can be separated out through a reaction between inner surfaces of Bi₂O₃—B₂O₃—SrCO₃ system glass tubes and HCl and H₂O. The BiOCl is the environment-friendly, economical and effective semiconductor photocatalytic material. With ultraviolet irradiation, the BiOCl semiconductor photocatalyst excites electron-hole pairs to generate OH and O^{2-.} free radicals with H₂O and O₂, thereby implementing degradation and removal of CHC pollutants. There are the following reaction formulas:

Bi₂O₃+6HCl=2BiCl₃+3H₂O;

BiCl₃+H₂O=BiOCl↓+2HCl.

Based on the above principle, the present disclosure employs the following technical solutions:

A first aspect of the present disclosure provides a device for degrading CHCs in polluted groundwater, including multiple Bi₂O₃—B₂O₃—SrCO₃ system glass tubes connected in series and parallel, an ultraviolet lamp provided in each of the glass tubes and a control power supply provided outside the glass tubes.

The Bi₂O₃—B₂O₃—SrCO₃ system glass tubes may be prepared as follows:

1) preparation of the glass tube: uniformly mixing 55-85 wt % of Bi₂O₃, 5-15 wt % of B₂O₃, and 10-30 wt % of SrCO₃, putting a resulting mixture into a corrosion resistant crucible and holding at 1,050-1,300° C. for 15-45 min, forming molten glass into a glass tube having a length-to-diameter ratio of 20-50 and a wall thickness of 2-5 mm, and holding the glass tube at 200-400° C. for 1-3 h, followed by cooling and annealing, to obtain the glass tube; and

2) etching of a self-cleaning glass tube: soaking an inner wall of the glass tube for 10-30 min with an HCl solution having a concentration of 0.02-0.2 mol/L, washing with water, and providing an ultraviolet lamp in the glass tube to obtain the self-cleaning glass tube.

Preferably, the ultraviolet lamp may be of a cylindrical shape; and a ratio of a diameter of the cylindrical ultraviolet lamp to an inner diameter of the glass tube may range from 1:2 to 1:10, and the ultraviolet lamp may have a power of 10-1,000 W/m, all of which are specifically determined according to a length of the glass tube.

A second aspect of the present disclosure provides a method for degrading CHCs in polluted groundwater, including the following steps:

A) assembly of the self-cleaning glass tubes: determining the number of parallel-connected glass tubes according to an amount of water, determining the number of series-connected glass tubes according to a CHC content in groundwater, and assembling the glass tubes into a self-cleaning glass tube kit;

B) pollutant degradation: guiding the CHC-containing groundwater to the self-cleaning glass tubes, turning on the ultraviolet lamps and carrying out the pollutant degradation for 0.5-8 h, thereby removing the CHCs; and

C) regeneration for catalytic performance of the self-cleaning glass tubes: re-etching the glass tubes for 1-10 min with the 0.02-0.2 mol/L HCl etchant, since catalytic performance of BiOCl growing on walls of the tubes may become weak due to long-time irradiation, the pollutant degradation, and sediment accumulation on inner surfaces of the tubes, thereby recovering the catalytic performance of the self-cleaning glass tubes.

Further, hydrogen peroxide may be added in step B) to improve the removal efficiency of the CHCs, and the hydrogen peroxide may have a mass fraction of less than 0.5%. The device may be re-etched after continuous operation of 15-30 d in step C).

In the present disclosure, in order to reduce the treatment cost, the Bi₂O₃, B₂O₃ and SrCO₃ materials for preparing the glass tubes may be replaced with waste materials containing corresponding chemical components. The HCl etchant can be recycled to reduce the cost.

The present disclosure has the following beneficial effects:

The Bi₂O₃—B₂O₃—SrCO₃ system glass is processed easily and has a stable structure and a certain strength. The glass in the system can react with the 0.02-0.2 mol/L HCl solution, such that the flaky-like BiOCl grows on the inner surfaces of the glass tubes. The BiOCl is the environment-friendly, economical and effective semiconductor photocatalytic material. When polluted groundwater containing the CHCs flows through the self-cleaning glass tubes, the BiOCl semiconductor photocatalyst on surfaces of the glass tubes excites the electron-hole pairs under ultraviolet irradiation to generate OH and O^{2-.} free radicals with H₂O and O₂, thereby effectively degrading the CHCs and other organic pollutants in the groundwater.

Compared with other methods, the degradation method in the present disclosure can degrade the CHCs in the groundwater without addition of a chemical agent, and does not involve agitation or separation of the catalyst and wastewater; and when the activity of the catalyst declines, it can be regenerated through simple soaking of 0.02-0.2 mol/L HCl solution, and the soaking solution can be recycled.

In addition, the present disclosure can adjust, according to the amount of wastewater and the concentration of CHC, the number of self-cleaning tubes connected in parallel and series. The present disclosure is continuous in reaction, low in cost, simple in operation and environment-friendly. With irradiation of the ultraviolet lamps for 1-8 h, the present disclosure can render the CHCs and other organic matters in the groundwater mineralized to a great extent for removal.

### BRIEF DESCRIPTION OF THE DRAWINGS

FIG. 1 is a schematic structural view of a device for degrading CHCs in polluted groundwater according to the present disclosure.

### DETAILED DESCRIPTION OF THE IMPLEMENTATION EXAMPLES

The following describe the implementations of the present disclosure in detail with reference to the accompanying drawings and the examples. The following examples are implemented on the premise of the technical solutions of the present disclosure, with the detailed implementations and specific operation processes. However, the protection scope of the present disclosure is not limited to the following examples.

All agents and raw materials used in the present disclosure are commercially available or prepared according to methods in literature. In the following examples, the experimental methods in which specific conditions are not stated are generally carried out according to conventional conditions or according to the conditions recommended by the manufacturer.

### Example 1 for Describing the Device for Degrading CHCs in Polluted Groundwater

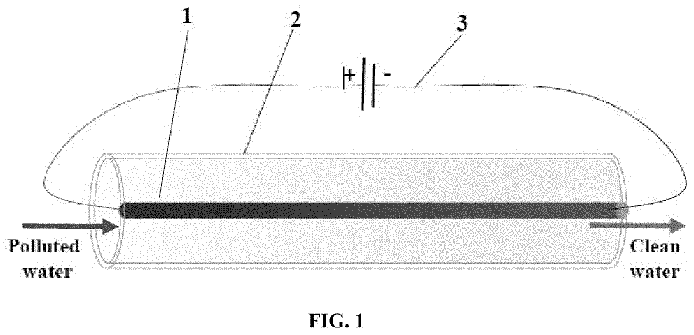

FIG. 1 shows a structure of a single device. The device includes multiple Bi₂O₃—B₂O₃—SrCO₃ system glass tubes 1 connected in series and parallel, an ultraviolet lamp 2 provided in each of the glass tubes and a control power supply 3 provided outside the glass tubes.

Each of the glass tubes 1 is internally hollow, and has a length-to-diameter ratio of 20-50 and a wall thickness of 2-5 mm. Only the basic structure of the device is shown in the FIGURE. As a matter of fact, there are further connectors provided in front and back as well as on the sidewall of the device to connect different glass tubes in series and parallel. The ultraviolet lamp 2 has a cylindrical shape. A ratio of a diameter of the cylindrical ultraviolet lamp to an inner diameter of the glass tube ranges from 1:2 to 1:10, and the ultraviolet lamp has a power of 100-1,000 W/m, all of which are specifically determined according to a length of the glass tube. The control power supply 3 is used to control the ultraviolet lamps 2.

The preparation method of the degradation device and the process and effect for degradation of the CHCs will be described respectively in Examples 2-4.

### Example 2

55 wt % of Bi₂O₃, 15 wt % of B₂O₃, and 30 wt % of SrCO₃ were uniformly mixed, put into a corrosion resistant crucible and held at 1,050° C. for 45 min, molten glass was formed into a glass tube having a length-to-diameter ratio of 20 and a wall thickness of 5 mm, and the glass tube was held at 400° C. for 1 h, cooled and annealed to obtain a glass tube. The inner wall of the glass tube was soaked for 30 min with an HCl solution (i.e., an etchant) having a concentration of 0.02 mol/L and washed by water, and a cylindrical ultraviolet lamp was provided in the glass tube.

CHC polluted groundwater with a total CHC content of 10 mg/L was taken, the CHC-containing groundwater was guided to the self-cleaning glass tube, the ultraviolet lamp was turned on, and pollutant degradation was carried out. With irradiation of the ultraviolet lamp for 1 h, the total content of CHCs in the groundwater was 0.2 mg/L. After continuous operation of the reaction device for 30 d, the degradation rate of the CHCs declines. The 0.02 mol/L HCl etchant was used to etch the device for 10 min to recover the catalytic degradation performance of the device to the initial state.

### Example 3

70 wt % of Bi₂O₃, 10 wt % of B₂O₃, and 20 wt % of SrCO₃ were uniformly mixed, put into a corrosion resistant crucible and held at 1,150° C. for 30 min, molten glass was formed into a glass tube having a length-to-diameter ratio of 35 and a wall thickness of 3 mm, and the glass tube was held at 300° C. for 2 h, cooled and annealed to obtain a glass tube. The inner wall of the glass tube was soaked for 20 min with a HCl solution (i.e., an etchant) having a concentration of 0.1 mol/L and washed by water, and a cylindrical ultraviolet lamp was provided in the glass tube.

CHC polluted groundwater with a total CHC content of 52 mg/L was taken, the CHC-containing groundwater was guided to the self-cleaning glass tube, the ultraviolet lamp was turned on, and pollutant degradation was carried out. With irradiation of the ultraviolet lamp for 4 h, the total content of CHCs in the groundwater was 2.8 mg/L. After continuous operation of the reaction device for 20 d, the degradation rate of the CHCs declines. The 0.1 mol/L HCl etchant was used to re-etch the device for 5 min to recover the catalytic degradation performance of the device to the initial state.

### Example 4

85 wt % of Bi₂O₃, 5 wt % of B₂O₃, and 10 wt % of SrCO₃ were uniformly mixed, put into a corrosion resistant crucible and held at 1,300° C. for 45 min, molten glass was formed into a glass tube having a length-to-diameter ratio of 50 and a wall thickness of 2.5 mm, and the glass tube was held at 400° C. for 1 h, cooled and annealed to obtain a glass tube. The inner wall of the glass tube was soaked for 10 min with a HCl solution (i.e., an etchant) having a concentration of 0.2 mol/L and washed by water, and a cylindrical ultraviolet lamp was provided in the glass tube.

CHC polluted groundwater with a total CHC content of 215 mg/L was taken, 0.15 wt % of hydrogen peroxide was added to the CHC polluted groundwater, the CHC-containing groundwater was guided to the self-cleaning glass tube, the ultraviolet lamp was turned on, and pollutant degradation was carried out. With irradiation of the ultraviolet lamp for 8 h, the total content of CHCs in the groundwater was 1.2 mg/L. After continuous operation of the reaction device for 15 d, the degradation rate of the CHCs declines. The 0.2 mol/L HCl etchant was used to etch the device for 1 min to recover the catalytic degradation performance of the device to the initial state.

The preferred examples of the disclosure have been described in detail above, but the disclosure is not limited to these examples. Those skilled in the art can make various equivalent variations or substitutions without departing from the spirit of the disclosure, and these equivalent variations or substitutions are all included in the scope defined by the claims of this application.

1. A device for degrading chlorinated hydrocarbons (CHCs) in polluted groundwater, comprising:
multiple Bi₂O₃—B₂O₃—SrCO₃ system glass tubes connected in series and parallel, an ultraviolet lamp provided in each of the glass tubes and a control power supply provided outside the glass tubes, wherein
the Bi₂O₃—B₂O₃—SrCO₃ system glass tubes are prepared as follows:
1) preparation of the glass tube: uniformly mixing 55-85 wt % of Bi₂O₃, 5-15 wt % of B₂O₃, and 10-30 wt % of SrCO₃, putting a resulting mixture into a corrosion resistant crucible and holding at 1,050-1,300° C. for 15-45 min, forming molten glass into a glass tube, and holding the glass tube at 200-400° C. for 1-3 h, followed by cooling and annealing, to obtain the glass tube; and
2) etching of a self-cleaning glass tube: soaking an inner wall of the glass tube for 10-30 min with an HCl solution having a concentration of 0.02-0.2 mol/L, washing with water, and providing an ultraviolet lamp in the glass tube to obtain the self-cleaning glass tube.

2. The device for degrading CHCs in polluted groundwater according to claim 1, wherein
the glass tube has a length-to-diameter ratio of 20-50 and a wall thickness of 2-5 mm.

3. The device for degrading CHCs in polluted groundwater according to claim 2, wherein
the ultraviolet lamp has a cylindrical shape; and a ratio of a diameter of the cylindrical ultraviolet lamp to an inner diameter of the glass tube ranges from 1:2 to 1:10.

4. The device for degrading CHCs in polluted groundwater according to claim 1, wherein the ultraviolet lamp has a power of 100-1,000 W/m.

5. A method for degrading chlorinated hydrocarbon (CHC) in polluted groundwater by using the device according to claim 1, comprising the following steps:
A) assembly of the self-cleaning glass tubes: determining the number of parallel-connected glass tubes according to an amount of water, determining the number of series-connected glass tubes according to a CHC content in groundwater, and assembling the glass tubes into a self-cleaning glass tube kit;
B) pollutant degradation: guiding the CHC-containing groundwater to the self-cleaning glass tubes, turning on the ultraviolet lamps and carrying out the pollutant degradation for 0.5-8 h, thereby removing the CHCs; and
C) regeneration for catalytic performance of the self-cleaning glass tubes: re-etching the glass tubes for 1-10 min with the 0.02-0.2 mol/L HCl etchant, since catalytic performance of BiOCl growing on walls of the tubes becomes weak due to long-time irradiation, the pollutant degradation, and sediment accumulation on inner surfaces of the tubes, thereby recovering the catalytic performance of the self-cleaning glass tubes.

6. The method for degrading CHCs in polluted groundwater according to claim 5, wherein
hydrogen peroxide is added in step B), and the hydrogen peroxide has a mass fraction of less than 0.5%.

7. The method for degrading CHCs in polluted groundwater according to claim 5, wherein the device is re-etched after continuous operation of 15-30 d in step C).
